(19) United States
(12) Patent Application Publication
(10) Pub. No.: US 2007/0247103 A1
(43) Pub. Date: Oct. 25, 2007

(54) Method and Apparatus for Controlling Power Supply to Induction Motors

(76) Inventors: John Lottman Shudde, San Antonio, TX (US); Igmar Avendano, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 11/738,134

(22) Filed: Apr. 20, 2007

Related U.S. Application Data
(60) Provisional application No. 60/793,752, filed on Apr. 22, 2006.

(51) Int. Cl. H02P 27/04

(52) U.S. Cl. 318/800

(57) ABSTRACT

A method for controlling power supply to an induction motor is disclosed. A baseline reactive power on an induction motor during operation is initially measured. A new reactive power for offsetting the baseline reactive power is determined. Appropriate capacitance is then applied on the power lines for the induction motor in order to supply the new reactive power to the induction motor. After the appropriate capacitance has been added to the induction motor, an instant reactive power on the induction motor is measured. A determination is made whether or not the instant reactive power on the induction motor is equal to or less than the new reactive power. If the instant reactive power is equal to or less than the new reactive power, the instant reactive power on the induction motor is continuously measured. If the instant reactive power is greater than the new reactive power, the added capacitance is removed from the power lines, and a new baseline reactive power is obtained.

### CROSS-REFERENCE TO RELATED APPLICATION

The present application claims the priority of a provisional patent application Ser. No. 60/793,752, filed Apr. 22, 2006, which is incorporated herein by reference.

### BACKGROUND OF THE INVENTION

1. Technical Field

The present invention relates to induction motors in general, and in particular to a method and apparatus for controlling power supply to induction motors. Still more particularly, the present invention relates to a method and apparatus for conserving energy consumptions in an induction motor.

2. Description of Related Art

The phase difference between the voltage supplied to an induction motor and the resulting current through the induction motor is indicative of the load on the induction motor. A power control system can be connected to an induction motor in order to compare the phase difference between the voltage supplied to the induction motor and the resulting current. Based upon the results of such comparison, the power control system may then control the voltage applied to the induction motor, which in turn controls the flow of current to the induction motor, in order to reduce the power consumed by the induction motor when the induction motor is operating under less than a fall load.

For example, if an excessively high value of supply voltage (in relation to the required level of motor torque) is applied while the induction motor is driving a very light load, then excessive drive current will lead to a relatively low operating efficiency. On the other hand, if the supply voltage is insufficiently high, then a sudden increase in the motor load may cause the induction motor to stall. Thus, when controlling an induction motor to operate with high efficiency over a wide range of motor load values, the basic objective is to apply an appropriate value of drive voltage to the induction motor for the load that is being imposed.

There are many prior art methods for controlling the supply of power to an induction motor in order to maximize the operating efficiency. However, those prior art methods are deficient with regard to preventing stalling or instability during low-load conditions or result in excessive power consumption under medium or low-load conditions. The above point can be illustrated by FIG. 1.

Referring now to the drawings and in particular to FIG. 1, there is depicted a graphical representation of optimum power factor verses motor load. As shown, a graph x represents the optimum values of power factor of an induction motor in the range from no load to full load, and the optimum power factor for a full-load operation is 80%. With the prior art induction motor control systems, the power factor is to be held at a constant value, such as 80% depicted in a graph y. However, considering operation with a load that is 50% of full load, the optimum power factor may actually be approximately 64%, but the system will still attempt to maintain the power factor at 80%. Thus, prior art induction motor control systems that are based on power factor detection cannot provide optimum efficiency of operation over a wide range of values of imposed motor load.

Consequently, it would be desirable to provide an improved method and apparatus for controlling power supply to an induction motor such that the induction motor can be operated efficiently under varying motor loads.

### SUMMARY OF THE INVENTION

In accordance with a preferred embodiment of the present invention, a baseline reactive power on an induction motor during operation is initially measured. A new reactive power for offsetting the baseline reactive power is determined. Appropriate capacitance is then applied on the power lines for the induction motor in order to supply the new reactive power to the induction motor. After the appropriate capacitance has been added to the induction motor, an instant reactive power on the induction motor is measured. A determination is made whether or not the instant reactive power on the induction motor is equal to or less than the new reactive power. If the instant reactive power is equal to or less than the new reactive power, the instant reactive power on the induction motor is continuously measured. If the instant reactive power is greater than the new reactive power, the added capacitance is removed from the power lines, and a new baseline reactive power is obtained.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a graphical representation of optimum power factor verses motor load;

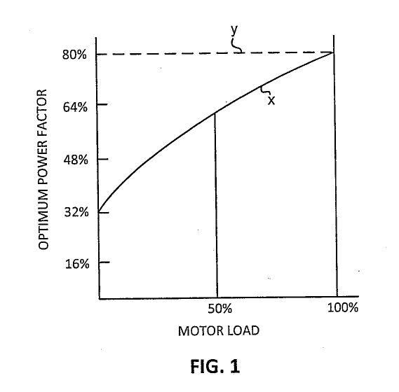

FIG. 2 is a block diagram of an apparatus for controlling power supply to an induction motor, in accordance with a preferred embodiment of the present invention; and

FIG. 3 is a high-level logic flow diagram of a method for controlling power supply to an induction motor, in accordance with a preferred embodiment of the present invention.

### DETAILED DESCRIPTION OF A PREFERRED EMBODIMENT

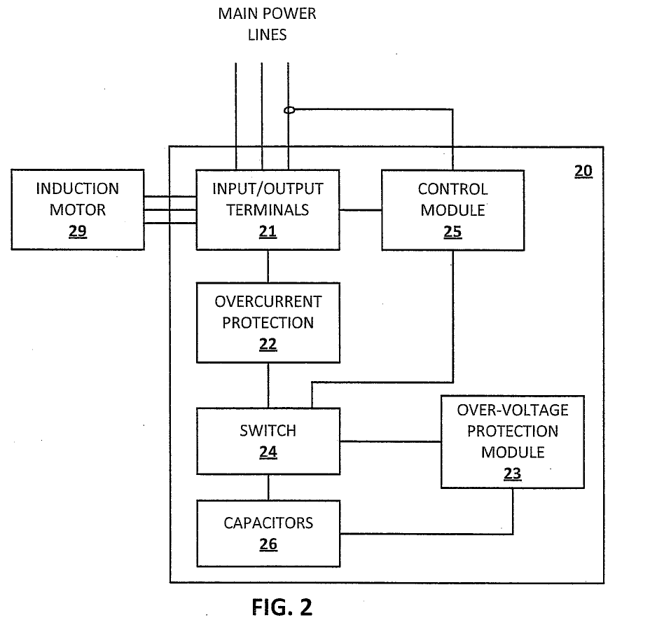

With reference now to FIG. 2, there is illustrated a block diagram of an apparatus for controlling power supply to an induction motor, in accordance with a preferred embodiment of the present invention. As shown, a power controller 20 includes an input/output terminals 21, an over-current protection module 22, an over-voltage protection module 23, a switch 24, a control module 25, and a set of capacitors 26. Input/output terminals 21 receive power from main power lines and, in turn, supply power to induction motor 29. Power controller 20 is connected to three-phase induction motor 29 via input/output terminals 21. By controlling switch 24 and the voltage and current on input/output terminals 21, power controller 20 is capable of controlling the supply of power to induction motor 29. Over-current protection module 22 and over-voltage protection module 23 protect power controller 20 from any current and voltage surges.

During the operation of induction motor 29, control module 25 continuously monitors the values on the main power lines (via a current transformer) and the various operating conditions of induction motor 29. Based on the operating conditions of induction motor 29, control module 25 controls switch 24 to allow a specific number of capacitors 26 to be coupled to induction motor 29 such that induction motor 29 can be operated efficiently under varying motor loads.

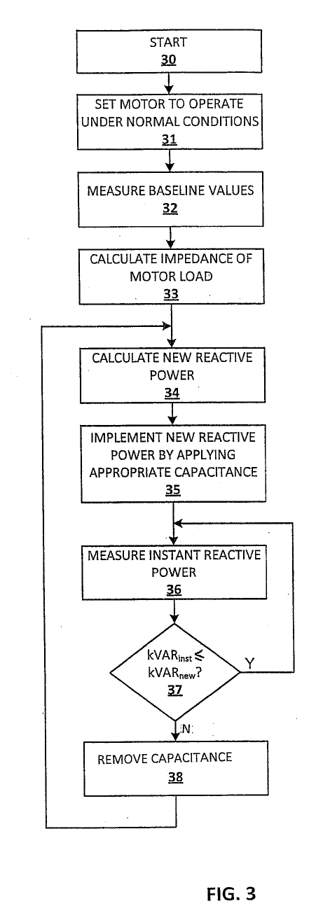

Referring now to FIG. 3, there is illustrated a high-level logic flow diagram of a method for controlling power supply to an induction motor, in accordance with a preferred embodiment of the present invention. Starting at block 30, an induction motor, such as induction motor 29 from FIG. 2, is set to operate under normal conditions, as shown in block 31. The voltage (V), current (I), the real power (kW), the reactive power (kVAR), the total power (kVA), and the power factor (PF) of the induction motor are measured, as depicted in block 32. Based on the values obtained from the above-mentioned measurements, which are considered as the baseline values for the operation of the induction motor, the impedance of the load on the induction motor is calculated, as shown in block 33. The impedance of the motor load Z can be calculated by

$$Z = \frac{{V}^{2}}{kVA} = R - jQ$$

where V=voltage
kVA=total power
R=real resistance
Q=reactive impedance

Next, a new reactive power for offsetting the baseline reactive power is calculated, as depicted in block 34. The new reactive power kVAR_{new} for offsetting the baseline reactive power kVAR_{base} can be calculated by

kVAR_{new}=kVAR_{base}+n

where kVAR_{new}=new reactive power
kVAR_{base}=baseline reactive power
n=any value equals to or less than 3

### Preferably, n=3, but n can be any value equals to or less than 3, depending on the operating condition of the induction motor.

Subsequently, the new reactive power kVAR_{new} is implemented by applying appropriate capacitance to the induction motor, as shown in block 35. In the configuration shown in FIG. 2, for example, one or more of capacitors 26 can be selectively connected to input/output terminals 21 via switch 24 that is controlled by control module 25 to provide the new reactive power kVAR_{new} to induction motor 29.

After the appropriate capacitance has been applied to the induction motor, the instant reactive power kVARᵢₙₛₜ of the induction motor is measured, as depicted in block 36. A determination is then made as to whether or not the instant reactive power kVARᵢₙₛₜ is equal to or less than the new operating reactive power kVAR_{new}, as shown in block 37. If the instant reactive power kVARᵢₙₛₜ is equal to or less than the new reactive power kVAR_{new}, then the process returns to block 36.

Otherwise, if the instant reactive power kVARᵢₙₛₜ is greater than the new reactive power kVAR_{new}, then the added capacitance from block 35 is removed, such as by disconnecting capacitors 26 from input/output terminals 21 in FIG. 2, as depicted in block 38, and the process returns to block 34.

As has been described, the present invention provides a method and apparatus for controlling power supply to induction motors.

It is also important to note that although the present invention has been described in the context of a fully functional control system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for controlling power supply to an induction motor, said method comprising:
measuring a baseline reactive power on an induction motor during operation;
determining a new reactive power for offsetting said baseline reactive power;
applying appropriate capacitance on power lines to said induction motor in order to supply said new reactive power to said induction motor;
measuring an instant reactive power on said induction motor after said appropriate capacitance has been added on said power lines to said induction motor;
determining whether or not said instant reactive power on said induction motor is equal to or less than said new reactive power;
in response to a determination that said instant reactive power is equal to or less than said new reactive power, continuously measuring an instant reactive power; and
in response to a determination that said instant reactive power is greater than said new reactive power, removing said added capacitance from said power lines and obtaining a new baseline reactive power.

2. The method of claim 1, wherein said new reactive power is said baseline reactive power+n, where n=any value equals to or less than 3.

3. The method of claim 1, wherein said applying further includes coupling at least one capacitor to said induction motor.

4. A computer usable medium having a computer program product for controlling power supply to an induction motor, said computer usable medium comprising:
computer program code for measuring a baseline reactive power on an induction motor during operation;
computer program code for determining a new reactive power for offsetting said baseline reactive power;
computer program code for applying appropriate capacitance on power lines to said induction motor in order to supply said new reactive power to said induction motor;
computer program code for measuring an instant reactive power on said induction motor after said appropriate capacitance has been added on said power lines to said induction motor;
computer program code for determining whether or not said instant reactive power on said induction motor is equal to or less than said new reactive power;
computer program code for, in response to a determination that said instant reactive power is equal to or less than said new reactive power, continuously measuring an instant reactive power; and
computer program code for, in response to a determination that said instant reactive power is greater than said new reactive power, removing said added capacitance from said power lines and obtaining a new baseline reactive power.

5. The computer usable medium of claim 4, wherein said new reactive power is said baseline reactive power+n, where n=any value equals to or less than 3.

6. The computer usable medium of claim 4, wherein said computer program code for applying further includes computer program code for coupling at least one capacitor to said induction motor.

7. A power controller for controlling power supply to an induction motor, said power controller comprising:
a control module for measuring a baseline reactive power on an induction motor during operation;
means for determining a new reactive power for offsetting said baseline reactive power;
a switch for applying appropriate capacitance on power lines to said induction motor in order to supply said new reactive power to said induction motor;
means for measuring an instant reactive power on said induction motor after said appropriate capacitance has been added on said power lines to said induction motor;
means for determining whether or not said instant reactive power on said induction motor is equal to or less than said new reactive power;
means for, in response to a determination that said instant reactive power is equal to or less than said new reactive power, continuously measuring an instant reactive power; and
means for, in response to a determination that said instant reactive power is greater than said new reactive power, removing said added capacitance from said power lines and obtaining a new baseline reactive power.

8. The power controller of claim 7, wherein said new reactive power is said baseline reactive power+n, where n=any value equals to or less than 3.

9. The power controller of claim 7, wherein said switch for applying further includes a switch for coupling at least one capacitor to said induction motor.
